(19) United States
(12) Patent Application Publication
(10) Pub. No.: US 2002/0188532 A1
(43) Pub. Date: Dec. 12, 2002

(54) Advertising in electronic books

(75) Inventor: Scott L. Rothstein, San Jose, CA (US)

Correspondence Address: FISH & RICHARDSON P.C., 500 ARGUELLO STREET, SUITE 500, REDWOOD CITY, CA, 94063, US

(73) Assignee: FISH & RICHARDSON PC

(21) Appl. No.: 09/522,641

(22) Filed: Mar. 10, 2000

(51) Int. Cl. G06F 17/60

(52) U.S. Cl. 705/29

(57) ABSTRACT

An apparatus and method for advertising in electronic documents. According to one implementation, the method includes receiving an electronic book, receiving one or more electronic ads, inserting the electronic ads into the electronic book to create an enhanced electronic book and sending the enhanced electronic book to a customer.

### BACKGROUND

The present invention relates generally to advertising within electronic documents.

The rapidly expanding popularity of the Internet has led to an explosion of useful information that is available to computer users at the click of a mouse. Much of this information takes the form of simple web pages. A web page is authored in Hypertext Markup Language (HTML), which provides a simple format for presenting simple textual and graphical information. Web pages generally provide small, bite-size, easily-digestible chunks of information that a user can quickly consume while seated before a desktop personal computer.

With the advent of small, portable computers and personal digital assistants (PDAs), users can take larger portions of information with them for consumption while away from the desk. Because a web page generally provides only a small portion of information, many web pages would be needed to constitute a portion of information large enough to keep a user occupied for a substantial length of time.

To satisfy this need, publishers have begun to provide more substantial electronic documents, which are referred to herein as “electronic books.” An example of an electronic book is a book that has been converted to electronic form for download and display. Electronic books have been developed for PDAs such as the PalmPilot and Windows CE devices. One supplier of such books is Peanut Press (www.peanutpress.com).

In addition, some suppliers have developed devices that are designed specifically for the receipt, storage and display of electronic books. Such devices are referred to herein as “electronic book readers.” In general, such a reader is compatible only with electronic books provided by the manufacturer of the reader.

### SUMMARY OF THE INVENTION

The present invention is a computer-implemented method for advertising in electronic books. According to one implementation, the method includes receiving an electronic book, receiving one or more electronic ads, inserting the electronic ads into the electronic book to create an enhanced electronic book and sending the enhanced electronic book to a customer.

In one aspect, a hyperlink to the enhanced electronic book is placed within a web page, and the enhanced electronic book is sent to a customer when the customer activates the hyperlink.

According to another aspect, the electronic ads are received from one or more advertisers. When an enhanced electronic book containing electronic ad associated with the advertiser is sent to a customer, a debit entry is created in the advertiser's account. Subsequently, the advertiser is billed according to the entries in the advertiser's account.

According to yet another aspect, the electronic book is received from a publisher. When an enhanced electronic book created from the electronic book received from the publisher is sent to a customer, a credit entry is created in the publisher's account. Subsequently, the publisher is compensated according to the entries in the publisher's account.

According to still another aspect, the location within the electronic book for insertion of an ad is determined according to one or more keywords associated with the electronic ad. The keywords can be supplied by the advertiser that provided the ad. Pages within the electronic book can be scored according to the keywords, and the location is selected according to the score.

In one implementation, the electronic book is in portable document format (PDF).

In another implementation, the electronic book is in a structured markup language file format, such as extensible markup language (XML) with extensible style sheet language (XSL).

In another implementation, electronic ads are inserted within a structured electronic document, such as a sound file or video file.

Advantages that can be seen in implementations of the invention include one or more of the following. Electronic books can be made available at little or no cost to customers. The present invention also provides a new channel for the flow of advertisements, and a convenient method for publishers to track ad revenues associated with their publications.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a high-level block diagram of a system in accordance with the invention.

FIG. 2 is a detailed block diagram of the system.

FIG. 3 is a flowchart of an implementation of a distributor.

FIG. 4 is a flowchart of an insertion process of FIG. 3.

FIG. 5 is a flowchart of a sending operation of FIG. 3.

Like reference numbers and designations in the various drawings indicate like elements.

### DETAILED DESCRIPTION

In one aspect, the present invention provides a computer-implemented method for collecting and inserting advertising within electronic books. An electronic book that includes inserted advertisements is referred to herein as an “enhanced electronic book.”

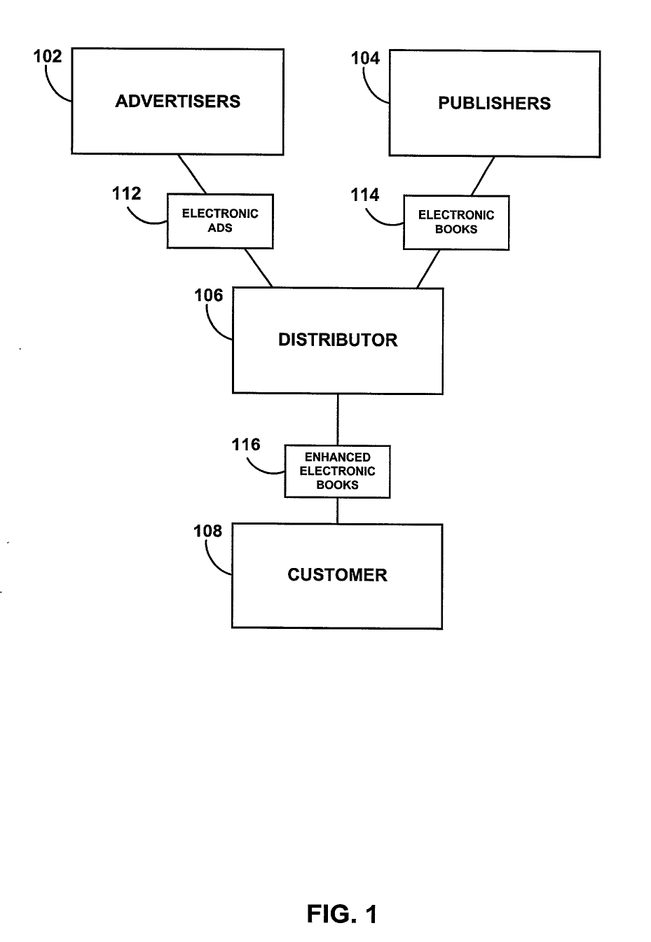

As shown in FIG. 1, an electronic book 114 is received from a publisher 104 by a distributor 106. Distributor 106 collects electronic ads 112 from advertisers 102 and converts the electronic ads to the format of the electronic book 114 before insertion into the electronic book. The location of insertion for each ad can be determined by several methods, such as by the location within the electronic book of keywords specified by the advertisers, as described in detail below.

Distributor 106 distributes the resulting enhanced electronic book 116 to customers 108 by methods such as posting the book on a web site. Customers can access the enhanced electronic book by using a personal computer or public kiosk. In addition, customers can download the book into an electronic document reader.

Accounting records are maintained for each advertiser and publisher. When an enhanced electronic book is accessed by a customer, the records for the publisher of the book, and for each advertiser associated with an ad in the book, are updated. Revenue is collected from the advertisers, and the publisher is compensated, based on the number of customers to which the enhanced electronic book is sent.

In another implementation, the advertisers compensate the publisher directly, and the publisher in turn compensates the distributor. In yet another implementation, the advertiser compensates only the distributor. The distributor in turn compensates the publisher.

In any of these implementations, the distributor can also compensate the author(s) of the book directly. Accounting records are maintained for each author, and the distributor compensates the authors.

These implementations can be governed by individual inter-party agreements, or by a single blanket agreement. Compensation can take any form, including cash, credits, scrip and the like.

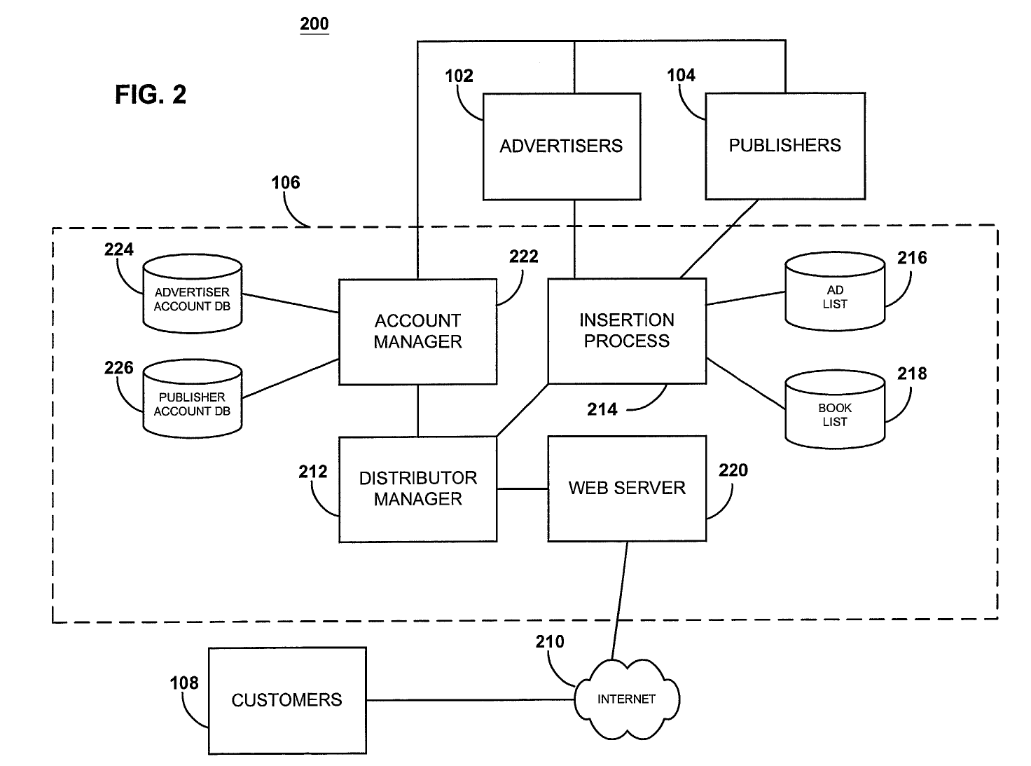

As shown in FIG. 2, distributor 106 generally interacts with customers 108 over Internet 210. Distributor 106 generally interacts with advertisers 102 and publishers 104 over the Internet.

Distributor 106 includes a distributor manager 212. The distributor manager controls the operation of the components of distributor 106. Insertion process 214 receives electronic ads from advertisers 102, and receives electronic books from publishers 104.

The electronic ads can be sent with keywords associated with each ad to be used in determining the location within an electronic book of the ad. The ads are stored in an ad list 216. Ad list 216 can be implemented as a table containing each ad submitted by an advertiser and the keywords associated with each ad. An example structure for the ad list is shown below in table 1.

TABLE 1

| | |
|---|---|
| Ad #1 | Keyword #1 |
| | Keyword #2 |
| Ad #2 | Keyword #1 |
| | Keyword #2 |
| | Keyword #3 |
| Ad #3 | Keyword #1 |
| | Keyword #2 |
| | Keyword #3 |
| | Keyword #4 |

In an alternative implementation, the keywords submitted by the advertisers can also be used to select the book in which the ad will be inserted. In another implementation, the distributor selects the books in which the ads are included, and the keywords associated with an ad determine the location of the ad within the book. When an ad has been associated with a book, the ad is entered into a book list 218.

The booklist includes each electronic book to be distributed. For each book, the booklist includes the publisher of the book, and the ads to be inserted within the book. An example structure for the booklist is shown in Table 2.

TABLE 2

| | | |
|---|---|---|
| Book #1 | Publisher of Book #1 | Ad #1 |
| | | Ad #2 |
| | | Ad #3 |
| Book #2 | Publisher of Book #2 | Ad #1 |
| | | Ad #2 |

For each electronic book in the booklist, the insertion process generates an enhanced electronic book by inserting the specified ads from the booklist within the electronic book. The enhanced electronic book is then posted on a web server 220. The book can be posted on the web server by placing a hyperlink to the enhanced electronic book within a web page hosted by the server 220. A customer 108 can access the web page using the Internet 210. When a customer activates the hyperlink, the enhanced electronic book corresponding to the hyperlink is sent to the customer. The book can be sent by several methods, including e-mail or a simple download from the web page.

An account manager 222 maintains account information for advertisers in advertiser account database 224. Account manager 222 maintains account information for publishers in publisher account database 226. When an enhanced electronic document is sent to a customer, the account information is updated to reflect the event. The account information is subsequently used to bill advertisers and compensate publishers.

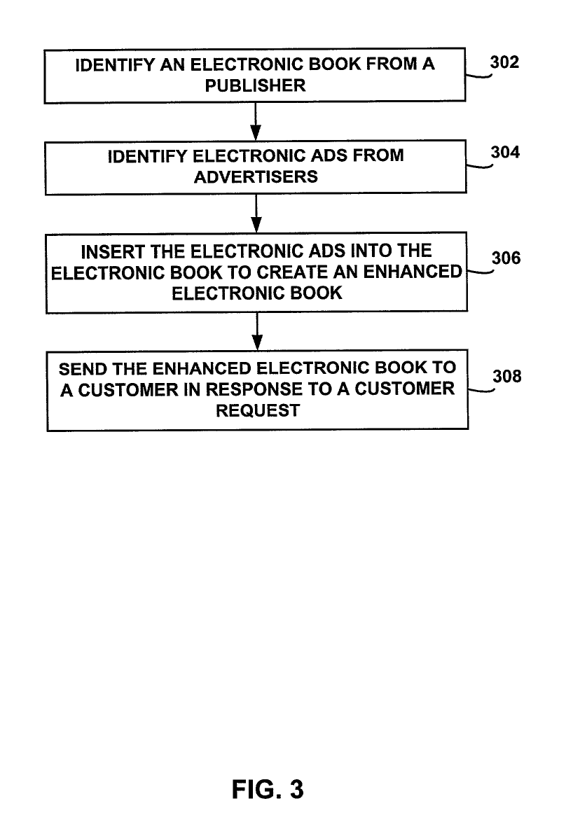

FIG. 3 is a flowchart depicting the operation of one implementation of distributor 106. In one implementation, the method of FIG. 3 is performed manually by a user manipulating a computer. In another implementation, the method of FIG. 3 is performed automatically, with little or no user intervention.

Distributor 106 identifies an electronic book from a publisher at step 302. As used herein, a “publisher” is any entity that provides an electronic book to distributor 106 for distribution. For example, publisher can be a commercial publishing house or one or more individual authors or editors.

Preferably, the format of the electronic book is portable document format (PDF). A PDF document document can be viewed and manipulated on a variety of different platforms and can be presented in a predetermined format where the appearance of the document as viewed by a reader is as it was intended by the publisher. PDF was developed by Adobe Systems, Incorporated of San Jose, Calif. An example of page-based software for TM creating, reading, and displaying PDF documents is the Acrobat™ software, also of Adobe Systems, Inc. The Adobe Acrobat software is based on Adobe's PostScript® technology, which describes formatted pages of a document in a device-independent fashion. An Acrobat program on one platform can create, display, edit, print, annotate, etc. a PDF document produced by another Acrobat program running on a different platform, regardless of the type of computer platform used. A document in a certain format or language can be translated into a PDF document using Acrobat. A PDF document can be quickly displayed on any computer platform having the appearance intended by the publisher, allowing the publisher to control the final appearance of the document.

One relatively new application for portable electronic documents is the retrieval of such documents from the “Internet”, the globally-accessible network of computers that collectively provides a large amount and variety of information for users. From services of the Internet such as the World Wide Web, users may retrieve or “download” data from Internet network sites and display the data that includes information presented as text in various fonts, graphics, images, and the like having an appearance intended by the publisher. A file format such as PDF that allows any platform to view a document having an appearance as intended by a publisher is thus of great value when downloading files from such widely-accessible and platform-independent network sources such as the Internet.

Alternatively, the electronic book format can be extensible markup language (XML) with extensible style sheet language (XSL). In other implementations, any structured markup language can be used. An additional format that can be used for the electronic book is the open e-book publication structure (OEB) format, which has been adopted by Microsoft and GlassBooks. The format can be found at http://www.openebook.org.

The electronic book is received by the distributor with no space reserved for ads. The distributor makes space in the electronic book to insert ads, for example, by adding pages of text in a PDF file or XML/XSL file.

Distributor 106 identifies one or more electronic ads from advertisers 102 at step 304. An “ad” or “advertisement” is a notice or announcement designed to attract public attention or patronage. An “electronic ad” is simply an ad in electronic form. An “advertiser” is any entity that provides an electronic ad. The electronic ad can contain a hyperlink to a web page of the advertiser. The electronic ad can be of any size, from a small insert within text, for example, to one or more full pages.

In one implementation, distributor 106 selects an element within the electronic book and hyperlinks the element to an advertiser's web site. For example, the word “hamburger” appearing in an electronic book could be hyperlinked to a web site for a chain of hamburger stands. A technique for generating such hyperlinks is disclosed in a copending patent application entitled “Method And System For Applying User Specified Hyperlinks”, application Ser. No. 09/124,463, filed Jul. 28, 1998, the disclosure thereof incorporated by reference herein in its entirety.

Distributor 106 inserts the electronic ads into the electronic book to create an enhanced electronic book at step 306. The locations are determined after the ads are received. Many methods can be used to determine the location of the electronic ads within the electronic book, as described in detail below.

Distributor 106 sends the enhanced electronic book to a customer in response to a request from the customer at step 308. The enhanced electronic book can be sent by conventional web-based methods, as well as by other electronic delivery methods.

The process of FIG. 3 is repeated for each ad to be inserted into the electronic book.

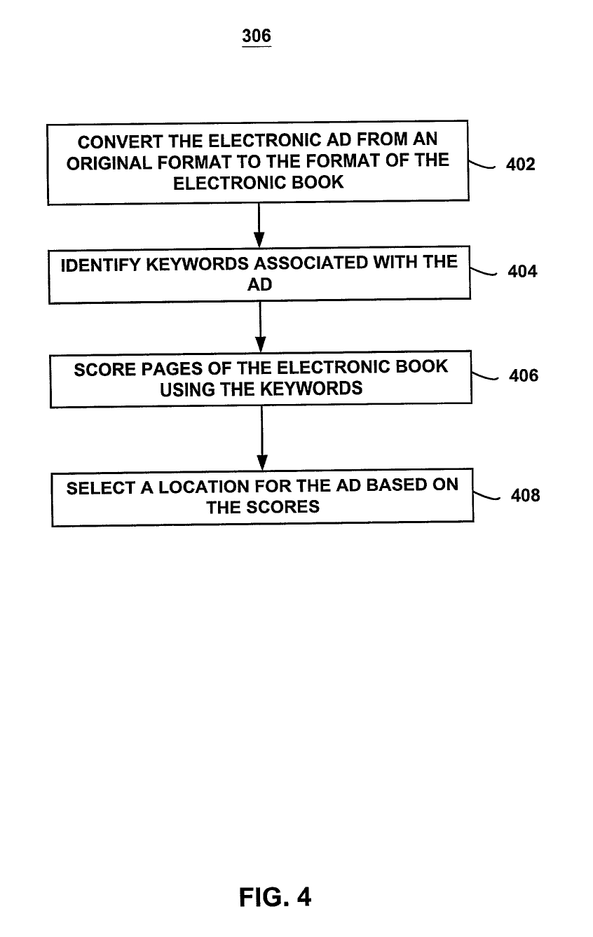

FIG. 4 is a flowchart describing one implementation of step 306 (FIG. 3) performed by insertion process 214 (FIG. 2).

Advertisers can supply electronic ads in formats other than the format of the electronic book. If this is the case, distributor 106 converts the electronic ad from its original format to the format of the electronic book at step 402.

Distributor 106 then identifies keywords associated with the ad at step 404.

Keywords for an ad can be supplied by the advertiser associated with the ad, or can be extracted from the ad by distributor 106 or some other entity. Distributor 106 uses the keywords to score the pages of the electronic book at step 406. Each page of the electronic book receives a score based on the presence of the keywords, and of any weighting applied to the keywords. Such scoring processes are well-known in the relevant arts. For example, such scoring processes are used by commercial search engines in evaluating web pages regarding user-supplied keywords. Distributor 106 then selects a location for the ad based on the scores at step 408.

Another technique for scoring, referred to as “Content Mining,” is available from eHNC Inc. The technique employs a combination of neural network or multivariate analysis routines with text analysis techniques to analyze the text content of one or more documents. The analysis allows for the numerical vector representation of the meaning of words, sections or entire documents. Further, the distance between the vectors represents the degree to which the words, sections or entire documents they represent are similar in meaning.

Many other processes can be used to determine the location for insertion within the electronic book of a particular ad or set of ads. For example, if no keywords are supplied, ads can be located randomly throughout the electronic book. Conversely, ads can be spaced evenly throughout the electronic book according to the number of ads to be inserted. Under any method, the location of the ads can be modified to coincide with section headings, the beginnings or ends of chapters, any drawings or figures within the electronic book, and the like. Extra weighting can be given to pages having matching keywords in section headings or chapter headings and the like. Ads can also be clustered in one area of the book, such as the start, end, or center.

In one implementation, an ad is inserted between successive pages of an electronic book. One advantage of this approach is that the content of the book is undisturbed. In another implementation, an ad is inserted within a page of an electronic book. One advantage of this approach is that an ad may be placed very close to a matching keyword. In this implementation, the content of the electronic book is modified to accommodate the ad. For example, the text can be reflowed around the ad. Reflowing can be accomplished by one or more operations of reducing text size, reducing text and spacing, and moving text.

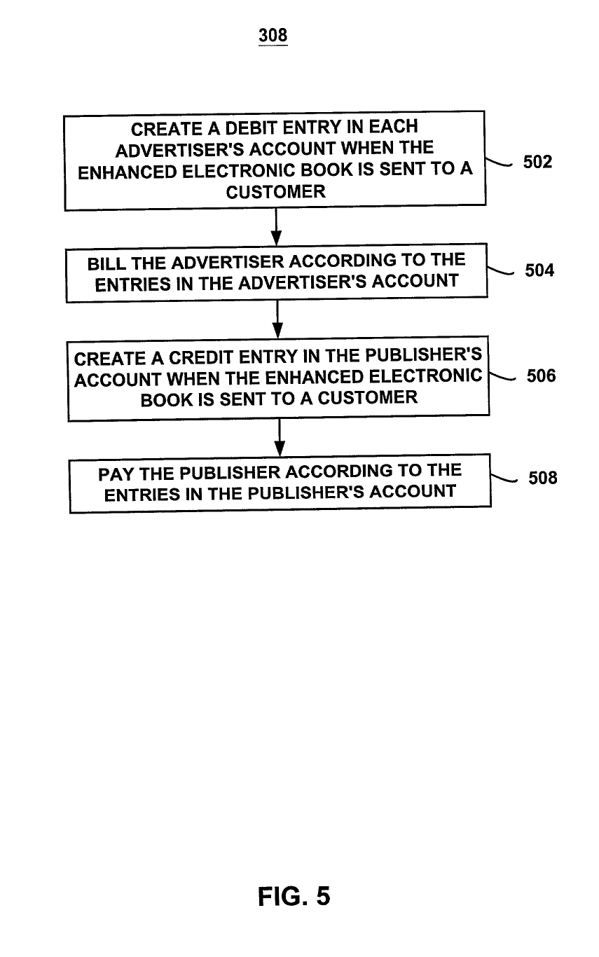

FIG. 5 is a flowchart of one implementation of step 308 (FIG. 3). The process of FIG. 5 is carried out by account manager 222. After sending the enhanced electronic document to a customer, distributor 106 creates a debit entry in the account of each advertiser having an ad in the book at step 502. These entries are made in advertiser accounts database 224. Subsequently, distributor 106 bills each advertiser according to the debit entries in the advertiser's account at step 504.

In one implementation the value of the debit entry is fixed. In another implementation, the value of a debit entry for an ad is determined by the location of the ad within the electronic book. For example, more valuable locations may be located near the front or end of the book, or near chapter headings and the like. Advertisers desiring these locations could be assessed larger debits accordingly.

Similarly, each time an electronic book is sent to a customer, distributor 106 also creates a credit entry in the account of the publisher of the book at step 506. These credit entries are made in publisher account database 226. Subsequently, distributor 106 compensates each publisher according to the credit entries in the publisher's account at 508.

In another implementation, the debit and credit entries are made in advance before the enhanced electronic document is posted, accessed or distributed. For example, these advance entries can be made based on predictions of the success of the book.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. In the above-described implementation, the electronic document distributed is an electronic book. However, the present invention is not so limited. Other embodiments are within the scope of the following claims. For example, the steps of the invention can be performed in a different order and still achieve desirable results.

As another example, the electronic document can be any structured electronic document. For example, the structured electronic document can be any document in portable document format (PDF).

As a further example, the structured electronic document can be a sound file, and the electronic advertisements are also sound files. As another example, the structured electronic document can be a video file, and the electronic ads can be video files.

In another implementation, the electronic ads are not inserted directly into the electronic document. Rather, the electronic ads are first inserted into a secondary electronic document, such as an electronic newspaper, which is then inserted within the electronic document.

What is claimed is:

1. A computer-implemented method comprising:
identifying an electronic book;
identifying one or more electronic ads; and
inserting the electronic ads into the electronic book to create an enhanced electronic book.

2. The computer-implemented method of claim 1, wherein the inserting step is performed automatically.

3. The computer-implemented method of claim 1, further comprising:
sending the enhanced electronic book to a customer.

4. The computer-implemented method of claim 3, wherein the enhanced electronic book is sent to the customer in response to a request from the customer.

5. The computer-implemented method of claim 4, further comprising:
placing a hyperlink to the enhanced electronic book within a web page; and
sending the enhanced electronic book to a customer when the customer activates the hyperlink.

6. The computer-implemented method of claim 1, wherein the inserting step comprises:
selecting an element of the electronic book; and
hyperlinking the element to a web page of the advertiser.

7. The computer-implemented method of claim 1, wherein an inserted electronic ad contains a hyperlink to a web page of an advertiser.

8. The computer-implemented method of claim 1, wherein an inserted electronic ad is a replica of a web page of an advertiser.

9. The computer-implemented method of claim 1, further comprising:
creating accounting entries for each enhanced electronic book.

10. The computer-implemented method of claim 9, wherein the electronic ads are received from one or more advertisers, further comprising:
creating a debit entry in an advertiser's account.

11. The computer-implemented method of claim 10, further comprising:
billing the advertiser according to the entries in the advertiser's account.

12. The computer-implemented method of claim 10, wherein a debit entry is created in an advertiser's account when an enhanced electronic book containing an electronic ad associated with the advertiser is accessed by a customer.

13. The computer-implemented method of claim 10, wherein the value of the debit entry is determined according to the location within the enhanced electronic book of an ad associated with the advertiser.

14. The computer-implemented method of claim 9, wherein the electronic book is received from a publisher, further comprising:
creating a credit entry in a publisher's account.

15. The computer-implemented method of claim 14, further comprising:
compensating the publisher according to the entries in the publisher's account.

16. The computer-implemented method of claim 14, wherein a credit entry is created in a publisher's account when an enhanced electronic book is accessed by a customer and the enhanced electronic book was created from an electronic book received from the publisher.

17. The computer-implemented method of claim 1, further comprising:
determining the location within the electronic book for the insertion of each electronic ad.

18. The computer-implemented method of claim 17, wherein the locations are determined after the ads are received.

19. The computer-implemented method of claim 17, wherein the locations are determined according to the number of ads to be inserted.

20. The computer-implemented method of claim 17, wherein the locations are determined according to one or more keywords associated with the electronic ad.

21. The computer-implemented method of claim 20, wherein the keywords are supplied by the advertiser.

22. The computer-implemented method of claim 21, wherein the location of an ad is determined according to a score representing the locations within the electronic book of keywords matching the keywords associated with the ad.

23. The computer-implemented method of claim 17, wherein the locations are determined according to the structure of the electronic book.

24. The computer-implemented method of claim 23, wherein a location is selected between successive pages of the electronic book.

25. The computer-implemented method of claim 23, wherein a location is selected within a page of the electronic book.

26. The computer-implemented method of claim 25, wherein the content of the page is modified to accommodate the ad.

27. The computer-implemented method of claim 26, wherein the content of the page is reflowed.

28. The computer-implemented method of claim 1, wherein the electronic book is in portable document format (PDF).

29. The computer-implemented method of claim 1, wherein the electronic book is a structured markup language file.

30. The computer-implemented method of claim 29, wherein the structured markup language file is in extensible markup language (XML) with extensible stylesheet language (XSL).

31. The computer-implemented method of claim 29, wherein the structured markup language file is in open e-book publication structure (OEB) format.

32. The computer-implemented method of claim 1, further comprising:
converting the electronic ad from an original format to the format of the electronic book.

33. A computer-implemented method comprising:
identifying a structured electronic document;
identifying one or more electronic ads; and
inserting the electronic ads into the structured electronic document to create an enhanced structured electronic document

34. The computer-implemented method of claim 33, further comprising:
sending the enhanced structured electronic document to a customer.

35. The computer-implemented method of claim 33, wherein the structured electronic document is a portable document format (PDF).

36. The computer-implemented method of claim 33, wherein the structured electronic document is a sound clip.

37. The computer-implemented method of claim 33, wherein the structured electronic document is a video clip.

38. The computer-implemented method of claim 33, further comprising:
compensating the supplier of the structured electronic document based on the number of times that the enhanced structured electronic document is accessed.

39. The computer-implemented method of claim 33, further comprising:
billing the supplier of the electronic ads based on the number of times that the enhanced structured electronic document is accessed.

40. A computer-implemented method comprising:
identifying a structured electronic document;
identifying one or more electronic inserts, at least one electronic insert containing an electronic ad; and
inserting the electronic insert into the structured electronic document to create an enhanced structured electronic document.

41. The computer-implemented method of claim 40, further comprising:
sending the enhanced structured electronic document to a customer.

42. The computer-implemented method of claim 40, wherein the structured electronic document is a portable document format (PDF).

43. The computer-implemented method of claim 40, wherein the structured electronic document is a sound clip.

44. The computer-implemented method of claim 40, wherein the structured electronic document is a video clip.

45. The computer-implemented method of claim 40, further comprising:
compensating the supplier of the structured electronic document based on the number of times that the enhanced structured electronic document is accessed.

46. The computer-implemented method of claim 40, further comprising:
billing the supplier of the electronic inserts based on the number of times that the enhanced structured electronic document is accessed.

47. A computer-implemented method comprising:
identifying an enhanced electronic book including one or more electronic ads; and
creating accounting entries associated with the enhanced electronic book.

48. The computer-implemented method of claim 47, wherein the electronic ads are associated with one or more advertisers, further comprising:
creating a debit entry in an advertiser's account.

49. The computer-implemented method of claim 58, further comprising:
billing the advertiser according to the entries in the advertiser's account.

50. The computer-implemented method of claim 47, wherein a debit entry is created in an advertiser's account when an enhanced electronic book containing an electronic ad associated with the advertiser is accessed by a customer.

51. The computer-implemented method of claim 50, wherein the value of the debit entry is determined according to the location within the enhanced electronic book of an ad associated with the advertiser.

52. The computer-implemented method of claim 50, wherein the electronic book is associated with a publisher, further comprising:
creating a credit entry in a publisher's account.

53. The computer-implemented method of claim 52, further comprising:
compensating the publisher according to the entries in the publisher's account.

54. The computer-implemented method of claim 52, wherein a credit entry is created in a publisher's account when an enhanced electronic book is accessed by a customer and the enhanced electronic book was created from an electronic book received from the publisher.
